(19) United States
(12) Patent Application Publication
(10) Pub. No.: US 2005/0186056 A1
(43) Pub. Date: Aug. 25, 2005

(54) Mounting system and method for supporting a lift platform on a vehicle floor

(76) Inventor: Donald A. Logan, Winnipeg (CA)

Correspondence Address: ADE & COMPANY, 1700-360 MAIN STREET, WINNIPEG, MB, R3C3Z3, CA

(21) Appl. No.: 11/063,237

(22) Filed: Feb. 23, 2005

Related U.S. Application Data
(60) Provisional application No. 60/546,209, filed on Feb. 23, 2004.

(51) Int. Cl. B60P 1/00

(52) U.S. Cl. 414/540

(57) ABSTRACT

A mounting system mounts a wheelchair lift system into a vehicle. The lift system is conventional, having a housing for being supported on a floor of a vehicle and a lift platform connected to the housing by a linkage for movement between an extended position on the ground adjacent the vehicle and a retracted position adjacent the floor of the vehicle. The mounting system comprises a mounting plate having mounting apertures formed therein for receiving fasteners to secure the mounting plate to the existing floor anchors for anchoring occupant seats in the floor of the vehicle. The plate also includes mounting means for mounting the housing of the lift system thereon.

### FIELD OF THE INVENTION

The present invention relates to a mounting system for supporting a lift platform on the floor of a vehicle.

### BACKGROUND

The use of lifts in various types of vehicles is known, for example to permit occupants in wheelchairs to be raised from the ground adjacent the vehicle, into the vehicle or for raising various cumbersome items into a vehicle. Typical lifts include a controller housing which mounts on the floor of the vehicle and which supports a platform for movement relative thereto by means of a linkage. The platform can be raised from a position outside of the vehicle on the ground to a raised position adjacent a floor of the vehicle by raising the platform with the linkage through a door opening of the vehicle. In a minivan this is typically accomplished through one of the sliding side doors of the vehicle.

Typical known lifts include a base which must be secured to the floor of the vehicle by forming new fastener apertures in the floor to which the base can be bolted. Dimensions of the base are approximately equal to the bottom of the housing in most instances. A large moment is placed on the fasteners at the base of the housing secured to the floor of the vehicle due to weight being applied on the cantilevered lift platform supported on the control housing through the linkage. Plural additional bolt holes are typically required in a side post of the vehicle alongside the door to anchor the top end of the control housing. Even with anchoring the housing at top and bottom ends thereof with multiple fasteners, the floor of the vehicle typically flexes and is distorted when weight is applied to the platform due to the small contact area of the housing on the floor. Furthermore once installed, the new fasteners which must be mounted into the floor and the side post of the vehicle cause damage to the vehicle which cannot be readily undone, thus considerably reducing resale value of the vehicle and possibly resulting in weakening of the vehicle structure.

### SUMMARY

According to one aspect of the present invention there is provided a mounting system for a vehicle mounted lift system having a housing for being supported on a floor of a vehicle having occupant seats supported on existing floor anchors of the vehicle and a lift platform connected to the housing by a linkage for movement between an extended position on the ground adjacent the vehicle and a retracted position adjacent the floor of the vehicle, the mounting system comprising:
a mounting plate having mounting apertures formed therein for receiving fasteners to secure the mounting plate to the floor of the vehicle, the mounting apertures being suitably spaced for securement to the existing floor anchors; and
mounting means for mounting the housing on the mounting plate.

According to a second aspect of the present invention there is provided a mounting system for a vehicle mounted lift system having a housing for being supported on a floor of a vehicle and a lift platform connected to the housing by a linkage for movement between an extended position on the ground adjacent the vehicle and a retracted position adjacent the floor of the vehicle, the mounting system comprising:
a mounting plate spanning an area plural times that of the housing and having mounting apertures formed therein for receiving fasteners to secure the mounting plate to the floor of the vehicle; and
means for mounting the housing on the mounting plate.

According to a further aspect of the present invention there is provided a method of mounting a lift system in a vehicle in which the lift system has a housing for being supported on a floor of the vehicle and a lift platform connected to the housing by a linkage for movement between an extended position on the ground adjacent the vehicle and a retracted position adjacent the floor of the vehicle, the method comprising:
providing a mounting plate having mounting apertures therein;
securing the mounting plate to the floor of the vehicle using fasteners received through the mounting apertures; and
mounting the housing on the mounting plate.

When the vehicle includes a side post having an existing anchor formed therein, the method may further include anchoring a top end of the housing to the existing anchor formed in the side post.

The mounting plate may span all seat anchors associated with one of the occupant seats.

The mounting means and the mounting apertures are preferably located on the mounting plate at a prescribed spacing corresponding to a type of the vehicle for proper alignment of the lift system with a door opening of the vehicle.

The mounting means may comprise threaded members welded onto the mounting plate to which the housing of the lift system can be secured.

Alternatively, the mounting means may comprise an adapter mount welded to the mounting plate upon which the housing can be mounted with threaded fasteners.

By providing a mounting plate which spans plural times the area of the housing and which can be secured to existing fasteners of the vehicle, the integrity of the vehicle is preserved so that the vehicle can be restored to its original configuration if it is desired to later remove the lift mechanism. Accordingly the plate is removed and original seats can be reinstalled within the pre-existing mounts in the vehicle floor. The use of a mounting plate further permits the mounting apparatus of the lift system to be accurately positioned in relation to fixed reference points of the vehicle in the form of existing mounts or anchors formed in the floor, thus proper positioning of the lift mechanism for clearance through the door opening of the vehicle is easily accomplished unlike the prior art in which several attempts and multiple unnecessary holes are frequently formed in the floor of the vehicle while adjusting the lift mechanism for proper alignment with the door opening. The broad nature of the mounting plate provides further strength to the floor of the vehicle which is sufficient to overcome flexing and distortion of the vehicle floor which would otherwise typically be present due to the large moments created by placing weight on the cantilevered lift platform. The added strength of anchoring to the floor also requires less anchoring at a top end of the control housing and accordingly fewer bolts or fasteners are required for securement to the side post at the door opening. Use of a single existing fastener location on the side post, for example an existing seatbelt mount will typically be sufficient for adequate support to the lift mechanism and accordingly no modifications in the form of new holes or otherwise non-reversible damage to the vehicle are necessary in either the floor or the side posts of the vehicle frame.

### BRIEF DESCRIPTION OF THE DRAWINGS

In the accompanying drawings, which illustrate exemplary embodiments of the present invention:

FIG. 1 is a perspective view of the mounting system;

FIG. 2 is a sectional view of a minivan having a lift system installed therein using the mounting system according to FIG. 1;

FIG. 3 is a partly sectional plan view of the minivan of FIG. 2; and

FIG. 4 is a perspective view of a further embodiment of the mounting system.

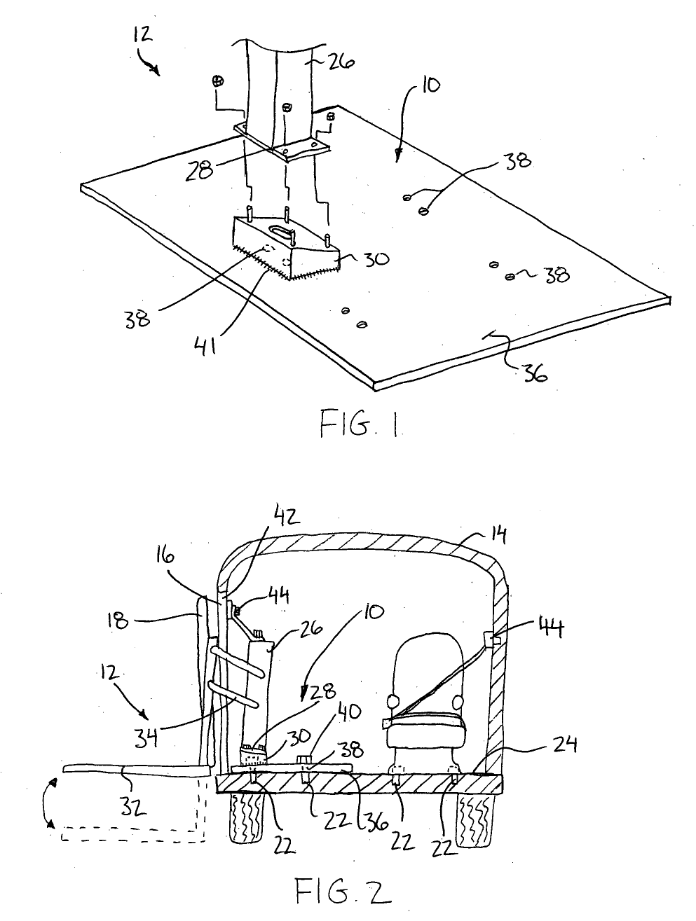

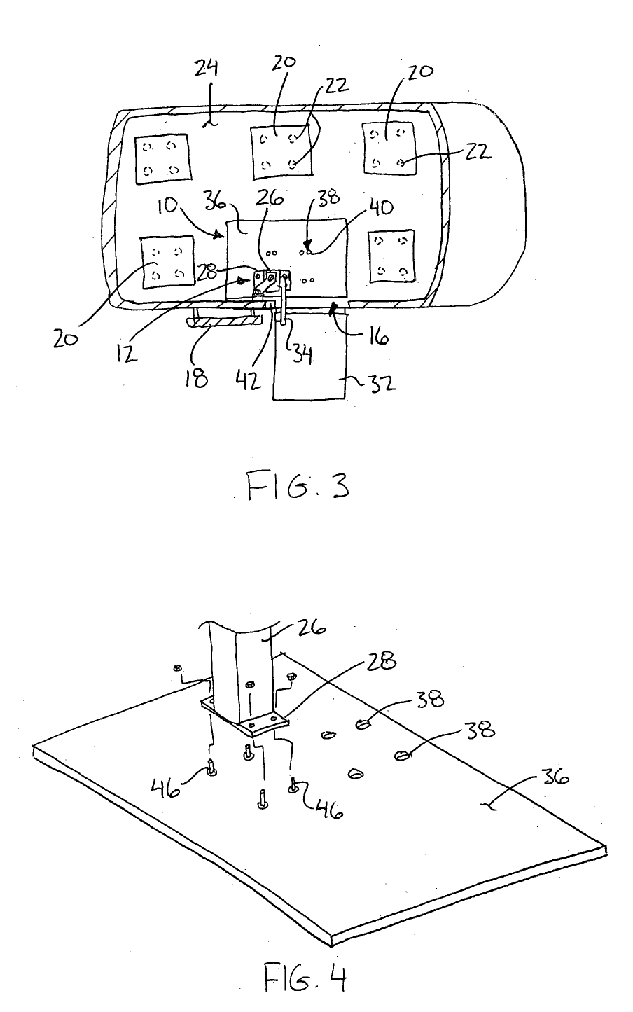

### DETAILED DESCRIPTION

Referring to the accompanying drawings, there is illustrated a mounting system generally indicated by reference numeral 10 which is particularly suited for mounting a lift system 12 into a vehicle 14, for example a wheelchair lift system for installation in a minivan and the like.

The vehicle 14 of the illustrated embodiment typically includes one or more side door openings 16 having a sliding door 18 for access to the interior of the vehicle. A plurality of passenger seats 20 are removably secured to existing seat anchors 22 in the floor 24 of the vehicle.

The lift system 12 of the illustrated embodiment includes an operating housing 26 having base 28 securable to the floor 24 of the vehicle by means of an adaptor mount 30. A lift platform 32 is supported on the operating housing by a suitable linkage 34 which permits the lift platform to be movable between an extended position resting on the ground beside a vehicle and a retracted position in which the lift platform is displaced upwardly to a level of the floor of the vehicle at the door opening 16 of the van.

The mounting system includes a rigid steel mounting plate 36 which spans plural times the length and width of the base of the control housing 26 so as to span plural times the area of the housing base. Mounting apertures 38 are provided in the plate 36 at prescribed locations and at prescribed spacings for alignment with existing mounts of the seat anchors 22 of the existing seats. Suitable threaded fasteners 40 are provided for securement of the mounting plate to the existing seat anchors 22 of the vehicle floor. The plate 36 is generally rectangular in shape in which one or more sides may be suitably shaped to conform with the interior profile of the walls of the vehicle. In the illustrated embodiment, the adaptor mount 30 of the system is welded onto the plate 36 at a prescribed location relative to the mounting apertures 38 which corresponds to alignment of the lift system with the door opening of the vehicle for the particular vehicle type which the mounting system is installed into.

Installation of the lift system using the mounting system 10 includes securing the base 28 or the adaptor mount 30 of the operating housing to the mounting plate at the prescribed location in relation to the mounting apertures so as to ensure alignment of the lift system with the door opening of the vehicle when the plate is mounted on the existing seat anchors 22.

The adaptor mount 30 is welded to the mounting plate as shown at seam 41 of FIG. 1, so that the base of the housing may be secured to the adaptor mount 30 by suitable fasteners. A suitable bracket is provided for anchoring a top portion of the control housing to an existing fastener anchoring location on the door post 42 along side the door opening of the vehicle. In the illustrated embodiment the existing mount on the door post comprises a seatbelt anchor 44 for the seat which was removed from the seat anchors 22 upon which the mounting plate is fastened. The mounting plate and door post 42 are then covered in a suitable manner to conform to the existing interior finishing of the vehicle. In the process of installation, no new holes are required to be formed in the van body or the frame of the van such that no modifications are required to the vehicle which are not fully reversible by simply removing selected fasteners and replacing the existing seats 20 which may have been removed.

In further embodiments, when the lift system comprises a pair of control housings, in which both housings can be secured to a common mounting plate 36. The plate would similarly be mounted to existing fasteners in the floor of the vehicle, and may span between existing mounts for plural seats of the vehicle for added strength. In place of welding the adaptor mount 30 or the base of the housing to the plate, suitable threaded posts 46 may be welded to the plate to which the housing or the adaptor mount can be bolted as shown in FIG. 4. The threaded posts would be located at a prescribed spacing from the mounting apertures depending upon the vehicle type so as to ensure alignment of the lift mechanism with the door opening of the vehicle when the mounting apertures are secured to the existing seat mounts using removable threaded fasteners.

While some embodiments of the present invention have been described in the foregoing, it is to be understood that other embodiments are possible within the scope of the invention. The invention is to be considered limited solely by the scope of the appended claims.

1. A mounting system for a vehicle mounted wheelchair lift system having a housing for being supported on a floor of a vehicle having occupant seats supported on existing floor anchors of the vehicle and a lift platform connected to the housing by a linkage for movement between an extended position on the ground adjacent the vehicle and a retracted position adjacent the floor of the vehicle, the mounting system comprising:
a mounting plate having mounting apertures formed therein for receiving fasteners to secure the mounting plate to the floor of the vehicle, the mounting apertures being suitably spaced for securement to the existing floor anchors; and
mounting means for mounting the housing on the mounting plate.

2. A mounting system for a vehicle mounted wheelchair lift system having a housing for being supported on a floor of a vehicle and a lift platform connected to the housing by a linkage for movement between an extended position on the ground adjacent the vehicle and a retracted position adjacent the floor of the vehicle, the mounting system comprising:
a mounting plate spanning an area plural times that of the housing and having mounting apertures formed therein for receiving fasteners to secure the mounting plate to the floor of the vehicle; and
means for mounting the housing on the mounting plate.

3. The system according to claim 2 for a vehicle having occupant seats supported on existing floor anchors of the vehicle wherein the mounting apertures are suitably spaced for securement to the existing floor anchors.

4. The system according to claim 2 wherein the mounting plate spans all seat anchors associated with one of the occupant seats.

5. The system according to claim 2 wherein the mounting means and the mounting apertures are located on the mounting plate at a prescribed spacing corresponding to a type of the vehicle for proper alignment of the lift system with a door opening of the vehicle.

6. The system according to claim 2 wherein the mounting means comprises threaded members welded onto the mounting plate to which the housing of the lift system can be secured.

7. The system according to claim 2 wherein the mounting means comprises an adapter mount welded to the mounting plate upon which the housing can be mounted with threaded fasteners.

8. A method of mounting a wheelchair lift system in a vehicle in which the lift system has a housing for being supported on a floor of the vehicle and a lift platform connected to the housing by a linkage for movement between an extended position on the ground adjacent the vehicle and a retracted position adjacent the floor of the vehicle, the method comprising:
providing a mounting plate having mounting apertures therein;
securing the mounting plate to the floor of the vehicle using fasteners received through the mounting apertures; and
mounting the housing on the mounting plate.

9. The method according to claim 8 wherein the vehicle includes occupant seats supported on existing floor anchors of the vehicle, the method including securing the mounting plate entirely to the existing floor anchors of the vehicle.

10. The method according to claim 8 wherein the mounting plate spans an area plural times that of the housing.

11. The method according to claim 8 wherein the vehicle includes a side post having an existing anchor formed therein, the method including anchoring a top end of the housing to the existing anchor formed in the side post.

12. The system according to claim 1 wherein the mounting plate spans all seat anchors associated with one of the occupant seats.

13. The system according to claim 1 wherein the mounting means and the mounting apertures are located on the mounting plate at a prescribed spacing corresponding to a type of the vehicle for proper alignment of the lift system with a door opening of the vehicle.

14. The system according to claim 1 wherein the mounting means comprises threaded members welded onto the mounting plate to which the housing of the lift system can be secured.

15. The system according to claim 1 wherein the mounting means comprises an adapter mount welded to the mounting plate upon which the housing can be mounted with threaded fasteners.
